(19) United States
(12) Patent Application Publication
(10) Pub. No.: US 2026/0056627 A1
(43) Pub. Date: Feb. 26, 2026

(54) TOUCH IDENTIFICATION METHOD AND CAPACITIVE TOUCH PANEL

(71) Applicant: BENQ CORPORATION, Taipei City (TW)

(72) Inventor: Chin-Jui Chi, Taipei (TW)

(73) Assignee: BENQ CORPORATION, Taipei City (TW)

(21) Appl. No.: 19/058,002

(22) Filed: Feb. 20, 2025

(30) Foreign Application Priority Data
Aug. 26, 2024 (TW) 113132018

(51) Int. Cl. G06F 3/041; G06F 3/044

(52) U.S. Cl. CPC G06F 3/0416; G06F 3/0446

(57) ABSTRACT

A touch identification method is applied to a capacitive touch panel having a capacitor array and an operation processor, and includes acquiring a sensing quantity parameter and a sensing area parameter generated by the activated capacitor array, comparing the sensing quantity parameter with a first preset condition, comparing the sensing area parameter with a second preset condition, and identifying an operation behavior applied for the capacitor array to accordingly output a control command in accordance with a first comparison result of the first preset condition and a second comparison result of the second preset condition.

### BACKGROUND OF THE INVENTION

### 1. Field of the Invention

The present application relates to a touch identification method and a capacitive touch panel, and more particularly, to a touch identification method of identifying diverse operation behaviors and a related capacitive touch panel.

### 2. Description of the Prior Art

When the conventional capacitive touch panel is pressed by an external object, the touch sensing layer is utilized to acquire the capacitive coupling change between the touch panel and the external object, for measuring the pressure exerted by the external object on the capacitive touch panel and the related control command; however, the conventional capacitive touch panel only detects the capacitive coupling change generated by the external object pressing the touch panel, and cannot identify the touch area of the touch panel applied by the external object. Therefore, the conventional capacitive touch panel cannot detect the radial size of the external object, and cannot identify diverse operation behaviors possibly provided by the external object.

### SUMMARY OF THE INVENTION

The present application provides a touch identification method of identifying diverse operation behaviors and a related capacitive touch panel for solving above drawbacks.

According to the claimed invention, a touch identification method is applied to a capacitive touch panel having a capacitor array and an operation processor. The touch identification method includes acquiring a sensing quantity parameter and a sensing area parameter generated by the capacitor array when being activated, comparing the sensing quantity parameter with a first preset condition, comparing the sensing area parameter with a second preset condition, and identifying an operation behavior applied for the capacitor array and accordingly output a control command in accordance with a first comparison result of the first preset condition and a second comparison result of the second preset condition.

According to the claimed invention, a capacitive touch panel includes a capacitor array and an operation processor. The operation processor is electrically connected with the capacitor array. The operation processor is adapted to acquire a sensing quantity parameter and a sensing area parameter generated by the capacitor array when being activated, compare the sensing quantity parameter with a first preset condition, compare the sensing area parameter with a second preset condition, and identify an operation behavior applied for the capacitor array and accordingly output a control command in accordance with a first comparison result of the first preset condition and a second comparison result of the second preset condition.

The touch identification method and the capacitive touch panel of the present application can analyze the sensing quantity parameter, the sensing area parameter, the sensing period and/or the sensing number of the capacitor array to simulate and identify diverse behaviors of the target object, so as to decide, adjust and change the property and the operation behavior of the target object, and further to implement the variety of control commands on the large-size touch panel for improving the operational convenience.

These and other objectives of the present application will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a capacitive touch panel according to an embodiment of the present application.

FIG. 2 is a flow chart of a touch identification method according to the embodiment of the present application.

### DETAILED DESCRIPTION

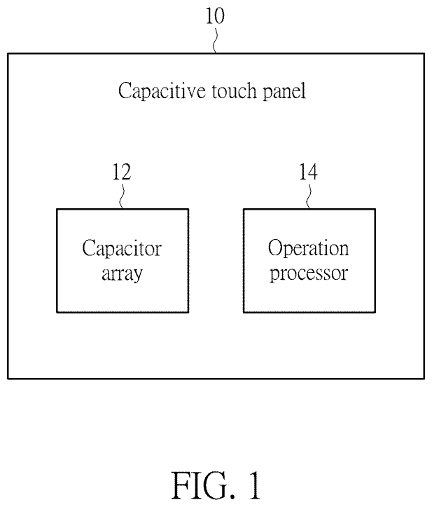

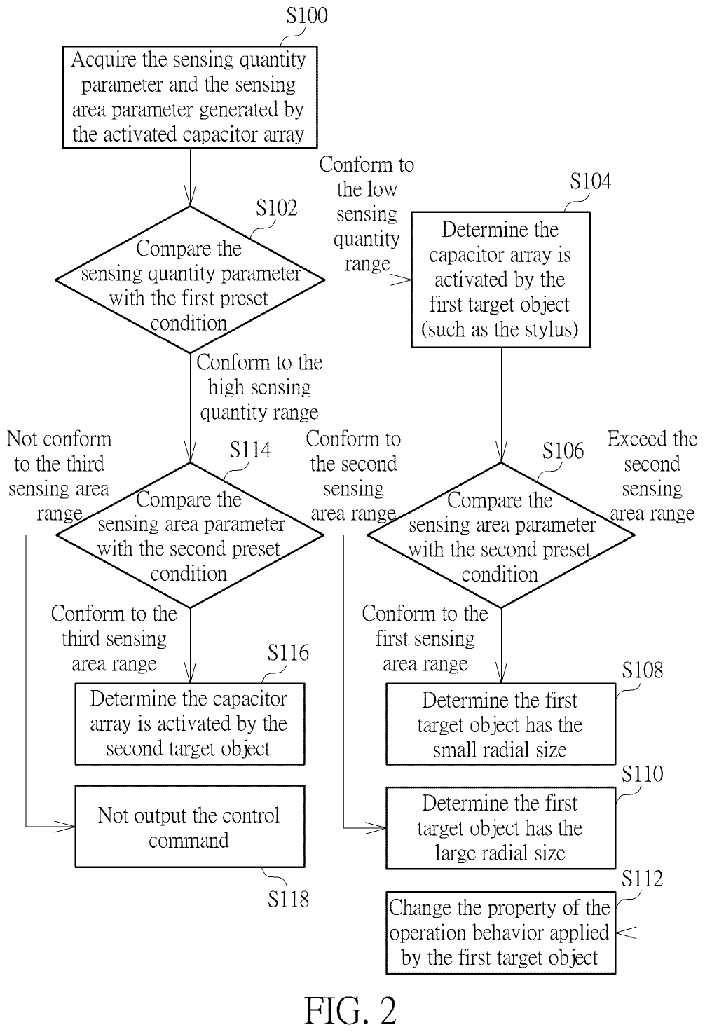

Please refer to FIG. 1 and FIG. 2. FIG. 1 is a functional block diagram of a capacitive touch panel 10 according to an embodiment of the present application. FIG. 2 is a flow chart of a touch identification method according to the embodiment of the present application. The capacitive touch panel 10 of the present application can be preferably applied for a large-size touch panel, such as an electronic whiteboard over 65 inches; however, the actual application is not limited to the foresaid embodiment. The touch identification method illustrated in FIG. 2 can be suitable for the capacitive touch panel 10 shown in FIG. 1. The capacitive touch panel 10 can at least include a capacitor array 12 and an operation processor 14, and other components are not essential technical features in the present application and therefore are omitted herein for simplicity. The capacitor array 12 can be an array formed by common capacitor sensors, and the detailed description is omitted. The operation processor 14 can be electrically connected to the capacitor array 12, and used to execute the touch identification method illustrated in FIG. 2.

According to the touch identification method, a storage unit (which is not marked in the figures) of the capacitive touch panel 10 can store a first preset condition and a second preset condition. The first preset condition can be relevant to a sensing quantity C of the capacitor array 12, and at least include a low sensing quantity range and a high sensing quantity range. The sensing quantity C can refer to a variable after conductive material contacts a capacitive touch element; different conductive materials may have its own fixed conductivity, but can have different sensing quantity when in contact with different capacitive touch elements. The second preset condition can refer to a sensing area A of the capacitor array 12, and optionally include a low sensing area range, a middle sensing area range and a high sensing area range. The sensing quantity C can correspond to the low sensing quantity range when being smaller than numeral 3, and can correspond to the high sensing quantity range when being greater than numeral 7.

In other embodiment, the first sensing quantity C1 can correspond to the low sensing quantity range, and the second sensing quantity C2 can correspond to the high sensing quantity range, and related formula can be set as 0<C1≤7, and C1*150%≤C2≤C1*300%. In another embodiment, the related formula can be set as 0<C1≤7, and C1*120%≤C2≤C1*200%. The sensing area A can correspond to the low sensing area range when being smaller than numeral 5, and can correspond to the middle sensing area range when being greater than numeral 5 and smaller than numeral 10, and can correspond to the high sensing area range when being greater than numeral 10.

In other embodiment, the first sensing area range A1 can correspond to the low sensing area range, the second sensing area range A2 can correspond to the middle sensing area range, and the third sensing area range A3 can correspond to the high sensing area range, and the related formula can be set as 0<A1≤5 mm and A1*150%≤A2≤A1*300%, and/or can be set as 5 mm<A2≤10 mm and A2*150%≤A3≤A2*300%. In another embodiment, the related formula can be set as 0<A1≤5 mm and A1*120% ≤A2≤A1*200%, and/or can be set as 5 mm<A 2≤10 mm and A2*120%≤A3≤A2*200%. Actual values of upper limits and lower limits of the foresaid sensing quantity range and the foresaid sensing area range are not limited to the reference data mentioned above, and can depend on detection sensitivity of the capacitor array 12.

The touch identification method of the present application can determine what kind of touch object is used to activate the capacitor array 12 in accordance with variation of the sensing quantity range and the sensing area range. For example, conductivity of a stylus is lower than conductivity of a human finger, and the first target object can be defined as the stylus and the second target object can be defined as the human finger; actual application of the target objects is not limited to the foresaid embodiments. In addition, a touch end of the stylus can activate different sensing areas on the capacitor array 12 due to its radial size, which means the stylus can be further interpreted as the thin stylus related to the first sensing area range A1 (such as the first target object with a first radial size), the thick stylus related to the second sensing area range A2 (such as the first target object with a second radial size), and the human finger related to the third sensing area range A3; the first radial size can be smaller than the second radial size. If the sensing area exceeds a preset range (such as being greater than the second sensing area range A2 or corresponding to the third sensing area range A3; the actual application is not limited to the foresaid embodiments), the present application can optionally modify definition of the first target object; for example, the first target object can be re-defined as the eraser. In the meantime, the touch identification method can change application of a track of the first target object from a drawing function to a wipe function.

First, the touch identification method can execute step S100 and step S102 to acquire a sensing quantity parameter and a sensing area parameter generated by the activated capacitor array 12, and compare the sensing quantity parameter with the first preset condition. When the sensing quantity parameter conforms to the low sensing quantity range, the object that contacts the capacitor array 12 can have low conductivity, and step S104 can be executed to determine the capacitor array 12 is activated by the first target object (such as the stylus), and an operation behavior applied for the capacitor array 12 can be the drawing function, so as to output a control command for displaying a line drawn on the capacitive touch panel 10.

Then, step S106 can be executed to compare the sensing area parameter with the second preset condition. When the sensing area parameter conforms to the first sensing area range A1, step S108 can be executed to determine the first target object has the first radial size (such as 3 mm thin stylus) and accordingly output the control command for displaying the thin line with first color on the capacitive touch panel 10. When the sensing area parameter conforms to the second sensing area range A2, step S110 can be executed to determine the first target object has the second radial size (such as 8 mm thick stylus), and accordingly output the control command for displaying the thick line with second color on the capacitive touch panel 10. The radial size of the stylus is not limited to the foresaid reference data, and may have an allowable error of 5% to 50%, or 10% to 20%, which depends on the actual demand.

Generally, the capacitive touch panel 10 of the present application can preset that the first color is different from the second color. When the user draws the line on the capacitive touch panel 10, the touch identification method can determine whether to display the thin line or the thick line in accordance with the second comparison result of the sensing area parameter and the second preset condition, and can preset color of the thin line is different from color of the thick line; however, actual application is not limited to the foresaid embodiment. For example, the first color may be the same as the second color, which means the touch identification method can draw and display the lines of different thicknesses by the same color. Accordingly, the touch identification method of the present application can change the color of the lines of different thicknesses based on other touch parameters, such as a sensing number within a preset period (which can be represented as a click behavior) and a sensing period of each click (which can be represented as a pressing behavior).

When the sensing area parameter exceeds the second sensing area range A2, the size of the touch object can be greater than the size of the thick stylus, and step S112 can be executed to change a property of the operation behavior applied by the first target object. For example, the present application can change the definition of the first target object from the stylus to the eraser, and the operation behavior of the user applied by the first target object can be switched from the drawing function to the wipe function.

When the sensing quantity parameter conforms to the high sensing quantity range, the object that contacts the capacitor array 12 can have high conductivity, and step S114 can be executed to compare the sensing area parameter with the second preset condition. When the sensing area parameter conforms to the third sensing area range A3, the object that contacts the capacitor array 12 can be the large-size object with high conductivity, and step S116 can be executed to determine that the capacitor array 12 is activated by the second target object (such as the 10 mm human finger), and accordingly output the control command for displaying an operation result with the third color on the capacitive touch panel 10. The third color may be the same as or different from the first color and/or the second color, which depends on the design demand. In one embodiment, the first color, the second color and the third color are different from each other. When the sensing area parameter does not conform to the third sensing area range A3, the object that contacts the capacitor array 12 can be any undefined object, and step S118 can be executed to not output the control command.

It should be mentioned that an execution result of step S118 may be varied in accordance with an operation mean of the capacitive touch panel 10. For example, when the sensing quantity parameter conforms to the high sensing quantity range, and the sensing area parameter conforms to the first sensing area range A1 or the second sensing area range A2 (or exceeds the third sensing area range A3), it may decide that the capacitor array 12 is activated by a third target object. The property and the operation behavior of the third target object can depend on the design demand, and the detailed description is omitted herein for simplicity.

In addition to the first comparison result of the sensing quantity parameter and the first preset condition, and the second comparison result of the sensing area parameter and the second preset condition, the touch identification method of the present application can identify the operation behavior applied to the capacitor array 12 and accordingly output the control command in accordance with the sensing period of the activated capacitor array 12, the sensing number of the activated capacitor array 12, and/or a sensing track of the activated capacitor array 12. As mentioned above, the sensing period can be defined as the operation behavior of continuously pressing the capacitive touch panel 10, the sensing number can be defined as the operation behavior of quickly clicking the capacitive touch panel 10, and the sensing track can be defined as the operation behavior of dragging on the capacitive touch panel 10.

For example, if the sensing period is 0.5 seconds and the sensing number is one time, the touch identification method of the present application can identify a click action; if the sensing period is 1 second and the sensing number is two times, the touch identification method of the present application can identify a double-click action. The sensing period, the sensing number and the sensing track can be varied in various combinations, which depend on the design demand. That is to say, the touch identification method of the present application can utilize the various combinations of the sensing period and the sensing number and the sensing track to preset different operation behaviors, such as clicking the specific application program, capturing or switching or clearing the display screen, setting or switching the color, clicking or copying or removing marked pattern on the display screen.

In conclusion, the touch identification method of the present application can be applied for the capacitive touch panel with the capacitor array and the operation processor. The touch identification method can include acquiring the sensing quantity parameter and the sensing area parameter generated by the activated capacitor array, comparing the sensing quantity parameter with the first preset condition, comparing the sensing area parameter with the second preset condition, and identifying the operation behavior applied by the capacitor array and accordingly output the control command based on the first comparison result of the first preset condition and the second comparison result of the second preset condition. The touch identification method and the capacitive touch panel of the present application can analyze the sensing quantity parameter, the sensing area parameter, the sensing period and/or the sensing number of the capacitor array to simulate and identify diverse behaviors of the target object, so as to decide, adjust and change the property and the operation behavior of the target object, and further to implement the variety of control commands on the large-size touch panel for improving the operational convenience.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch identification method applied to a capacitive touch panel having a capacitor array and an operation processor, the touch identification method comprising:
utilizing the operation processor to acquire a sensing quantity parameter and a sensing area parameter generated by the capacitor array when being activated;
utilizing the operation processor to compare the sensing quantity parameter with a first preset condition;
utilizing the operation processor to compare the sensing area parameter with a second preset condition; and
utilizing the operation processor to identify an operation behavior applied for the capacitor array and accordingly output a control command in accordance with a first comparison result of the first preset condition and a second comparison result of the second preset condition.

2. The touch identification method of claim 1, wherein the first preset condition comprises a low sensing quantity range and a high sensing quantity range, the touch identification method further comprises:
the operation processor determining the capacitor array is activated by a first target object when the sensing quantity parameter conforms to the low sensing quantity range.

3. The touch identification method of claim 2, wherein the second preset condition comprises a first sensing area range and a second sensing area range, the touch identification method further comprises:
the operation processor determining the first target object has a first radial size when the sensing area parameter conforms to the first sensing area range; or
the operation processor determining the first target object has a second radial size when the sensing area parameter conforms to the second sensing area range.

4. The touch identification method of claim 3, further comprising:
the operation processor changing a property of the operation behavior applied by the first target object when the sensing area parameter exceeds the second sensing area range.

5. The touch identification method of claim 3, further comprising:
the operation processor determining the capacitor array is activated by a second target object when the sensing quantity parameter conforms to the high sensing quantity range and the sensing area parameter exceeds the second sensing area range;
wherein a conductivity of the second target object is greater than a conductivity of the first target object.

6. The touch identification method of claim 5, further comprising:
the operation processor outputting the control command related to a first color when the capacitor array is activated by the first target object and the first target object has the first radial size;
the operation processor outputting the control command related to a second color when the capacitor array is activated by the first target object and the first target object has the second radial size; and
the operation processor outputting the control command related to a third color when the capacitor array is activated by the second target object.

7. The touch identification method of claim 1, further comprising:
the operation processor identifying the operation behavior and accordingly outputting the control command in accordance with the first comparison result, the second comparison result, and a sensing period and a sensing number of the capacitor array when being activated.

8. The touch identification method of claim 1, further comprising:
the operation processor identifying the operation behavior and accordingly outputting the control command in accordance with the first comparison result, the second comparison result, and a sensing period and a sensing number and a sensing track of the capacitor array when being activated.

9. The touch identification method of claim 1, wherein the touch identification method is applied for a capacitive touch panel over 65 inches.

10. A capacitive touch panel comprising:
a capacitor array; and
an operation processor electrically connected with the capacitor array, the operation processor being adapted to acquire a sensing quantity parameter and a sensing area parameter generated by the capacitor array when being activated, compare the sensing quantity parameter with a first preset condition, compare the sensing area parameter with a second preset condition, and identify an operation behavior applied for the capacitor array and accordingly output a control command in accordance with a first comparison result of the first preset condition and a second comparison result of the second preset condition.

11. The capacitive touch panel of claim 10, wherein the first preset condition comprises a low sensing quantity range and a high sensing quantity range, the operation processor is adapted to further determine the capacitor array is activated by a first target object when the sensing quantity parameter conforms to the low sensing quantity range.

12. The capacitive touch panel of claim 11, wherein the second preset condition comprises a first sensing area range and a second sensing area range, the operation processor is adapted to further determine the first target object has a first radial size when the sensing area parameter conforms to the first sensing area range, or determine the first target object has a second radial size when the sensing area parameter conforms to the second sensing area range.

13. The capacitive touch panel of claim 12, wherein the operation processor is adapted to further change a property of the operation behavior applied by the first target object when the sensing area parameter exceeds the second sensing area range.

14. The capacitive touch panel of claim 12, wherein the operation processor is adapted to further determine the capacitor array is activated by a second target object when the sensing quantity parameter conforms to the high sensing quantity range and the sensing area parameter exceeds the second sensing area range, and a conductivity of the second target object is greater than a conductivity of the first target object.

15. The capacitive touch panel of claim 14, wherein the operation processor is adapted to further output the control command related to a first color when the capacitor array is activated by the first target object and the first target object has the first radial size, output the control command related to a second color when the capacitor array is activated by the first target object and the first target object has the second radial size, and output the control command related to a third color when the capacitor array is activated by the second target object.

16. The capacitive touch panel of claim 10, wherein the operation processor is adapted to further identify the operation behavior and accordingly outputting the control command in accordance with the first comparison result, the second comparison result, and a sensing period and a sensing number of the capacitor array when being activated.

17. The capacitive touch panel of claim 10, wherein the operation processor is adapted to further identify the operation behavior and accordingly outputting the control command in accordance with the first comparison result, the second comparison result, and a sensing period and a sensing number and a sensing track of the capacitor array when being activated.

18. The capacitive touch panel of claim 10, wherein the capacitive touch panel is over 65 inches.
